(19) United States
(12) Patent Application Publication
(10) Pub. No.: US 2005/0020739 A1
(43) Pub. Date: Jan. 27, 2005

(54) Derivatives of 9,10-dihydro-9-oxa-10-phosphaphenanthrene-10-oxide

(75) Inventors: Uwe Dittrich, Radebeul (DE); Berthold Just, Hamburg (DE); Manfred Doring, Worth-Buchelberg (DE); Michael Ciesielski, Merseburg (DE)

Correspondence Address: WILLIAM COLLARD;COLLARD & ROE, P.C., 1077 NORTHERN BOULEVARD, ROSLYN, NY, 11576, US

(73) Assignee: SCHILL + SEILACHER "STRUKTOL" AKTIENGESELLSCHAFT

(21) Appl. No.: 10/890,035

(22) Filed: Jul. 13, 2004

(30) Foreign Application Priority Data
Jul. 16, 2003 (DE) 103 32 291.4

(51) Int. Cl. C08K 5/49; C07F 9/02

(52) U.S. Cl. 524/117; 524/118; 558/83

(57) ABSTRACT

Novel derivatives of 9,10-dihydro-9-oxa-10-phosphaphenanthrene-10-oxide, processes for their preparation and the use of the derivatives for flame protection of natural products and plastics are disclosed.

The invention relates to novel derivatives of 9,10-dihydro-9-oxa-10-phosphaphenanthren-10-oxide, processes for their preparation and the use of the derivatives for flame protection of natural products and plastics.

The use of special phosphororganic compounds for flame protection of natural products and plastics is known. For example DE-OS-2 034 887 describes 9,10-dihydro-9-oxa-10-phosphaphenanthrene-10-oxide.(DOP) and derivatives thereof as flame-resistance products, substituents being optionally provided on the phosphorus atom.

Further, EP-A-0 806 429 discloses derivatives of 4-hydroxybutane-1-phosphinic acid and/or of its intramolecular ester, an epoxy functionalization being provided at the phosphorus (see also M. J. Alcon, M. A. Espinosa, M. Galia and V. Cadiz in Macromol. Rapid Comm. 2001, 22, 1265-71). One possible intramolecular phosphinic acid ester is DOP. The unexamtined patent application concerns itself in detail with the flameproof finishing of epoxide resins.

EP-A1-1 279 719 describes flame-retardant fibre-treatment products based on derivatives of DOP. Alkyl, hydroxyalkyl, aralkyl, succinimide, hydroxyl, alkoxy or aralkoxy groups are provided as substituents at the phosphorus. In U.S. Pat No. 4,228,064 similar compounds are proposed for the preparation of polyphenylene ether resin compositions with flame-retardant finish.

DE-A-100 06 592 discloses phosphinic acid derivatives, among others phosphinic acid amides. In J. Organomet. Chem. 1968, 13, 199 the preparation of methylenebisphosphonic acid tetraalkyl esters, the metalation of the esters at the methylene group and subsequent reactions are described. The article does not concern itself with flame-protection products.

J. prakt. Chemie 1974, 316, 550 relates to the reaction of trialkyl orthoformate with anhydrous phosphoric acid. The reaction with orthoester results in diethyl phosphite (“O-alkylation”) and dialkoxymethylphosphonic acid dialkylester (“P-dialkoxymethylation”). The reaction is also possible with P₄O₆.

In the Chemical Abstract 39732u relating to the publication Zh. Obshch. Khim. 37(7), 1623-1626 (1967) the reaction of phosphonic acid dialkyl esters with ortho esters is described. Reactions of phosphinic acid esters and a use of phosphinic acid derivatives for flame protection are not mentioned.

In Tetrahedron Lett. 34, 1977, 2987-90 the action of excess trimethyl orthoformate acid on phosphinic acid is disclosed which leads to the formation of a number of products. No aryl-substituted phosphinic acids are reacted however. Also, the article concerns itself not with flame-protection products, but with the explanation of a tautomeric equilibrium of disubstituted phosphinic oxide.

The invention in the patent application filed at the German Patent and Trademark Office on 20th Feb. 2002 with the official file number DE 102 06 982.4 relates to the reaction of certain derivatives of DOP with alcohols while exposed to an ortho ester. The reaction products are diesters of hypophosphoric acid (phosphonous acid).

In Zh. Obshch. Khim. 34(9), 3125-6 (1964) A. I. Razumov and V. V. Moskva describe the P-dialkoxymethylation of phosphonic acid diesters.

The esterification and N-formylation of aminoethanebisphosphonic acids with triethyl orthoformate is described in J. prakt. Chemie 1979, 321, pages 361-369. There is no discussion of flame-protection products.

Requirements to be satisfied by an up-to-date flameproof finish for natural products and plastics are among others no deterioration of the mechanical and chemical properties, such as e.g. strength, modulus, thermoforming resistance, resistance to solvents and aggressive chemicals. A deterioration of the electrical properties is however equally undesired. Also a reduction of the adhesion of adhesives or adhesion to tissues during the prepreg- or composite preparation when used with epoxide resins is basically to be ruled out. Also, storage stabilities of single-component systems (e.g. adhesive, prepregs) which already contain a curing agent must not be negatively influenced. In addition there is always a demand for flameproof products which are particularly heat- and hydrolysis-stable.

In view of these requirements there is a need for an improved flameproof finish for natural products and plastics. It is therefore the object of the invention to prepare new compounds and compositions which are suitable for the named purpose. The object also includes the provision of a process for the preparation of the new compounds and compositions. In addition the object relates to the provision of new flameproof-finished natural products or plastics.

These objects are achieved by the embodiments of the invention described in the independent patent claims. Preferred embodiments are disclosed in the dependent claims.

The novel compounds are derivatives of 9,10-dihydro-9-oxa-10-phosphapenanthrene-10-oxide with the Formula I 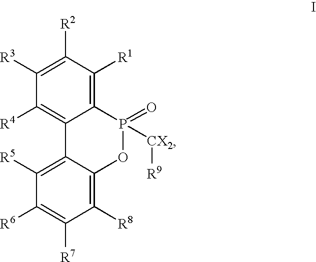
in which
R¹ to R³ independently of each other are a hydrogen atom, halogen atom or a hydrocarbon group,
R⁹ is a hydrogen atom or a hydrocarbon group and
the radicals X are the same or different and mean OR¹⁰ or NR¹⁰R¹¹ , and R¹⁰ and R¹¹ are the same or different hydrocarbon groups, R¹¹ also being able to be a hydrogen atom
   the radicals R¹ to R¹¹ independently of each other optionally containing one or more heteroatoms selected from oxygen, nitrogen, sulphur, phosphorus, silicon and halogen,
   two or more of the radicals R¹ to R⁸ optionally being linked to form one or more cycles and
   the radicals R¹⁰ and R¹¹ optionally being linked to form a cycle.

The two radicals X are preferably the same.

The derivatives according to the invention are aminals and ketals or acetals, or combinations thereof, derived from P-acyl- or P-formyl-substituted compounds and from 9,10-dihydro-9-oxa-10-phosphaphenanthrene-10-oxide and its derivatives.

A particular advantage of the derivatives according to the invention is their universal applicability, as through a suitable choice of R¹⁰ and/or R¹¹ it is possible to introduce functionalizations into the derivative which make possible a reactive incorporation of the derivatives into the natural or synthetic resin to be given a flameproof-finish, which leads to an improvement in the mechanical properties of the natural products or plastics with a flame-retardant finish. On the other hand the preparation of natural products and plastics with an additive flameproof finish is possible if a reactive incorporation via functional groups at R¹⁰ and/or R¹¹ is not desired or not necessary.

The derivatives according to the invention are characterized by a high temperature- and hydrolysis-stability which is to be attributed to inter alia the particular functionalization of the phosphorus atom. This advantage is present regardless of whether the derivative according to the invention is reactively bound into the natural or artificial product with a flameproof finish or is present therein as an additive.

Although a substitution pattern is possible in which all the radicals R¹, R², R³ and R⁴ independently of each other are a halogen atom or a hydrocarbon group, a preferred embodiment relates to the case that, of the radicals R¹, R², R³ and R⁴, at least two, preferably at least three are hydrogen atoms, in particular R¹, R² R³ and R⁴ are all hydrogen atoms.

Although a substitution pattern is possible in which all the radicals R⁵, R⁶, R⁷ and R⁸ independently of each other are a halogen atom or a hydrocarbon group, a preferred embodiment relates to the case that, of the radicals R⁵, R⁶, R⁷ and R⁸, at least two, preferably at least three are hydrogen atoms, and in particular R⁵, R⁶, R⁷ and R⁸ are all hydrogen atoms.

Substitution patterns at the aromatic ring systems are preferred in which in each case two of the radicals R¹, R², R³ and R⁴ and of the radicals R⁵, R⁶, R⁷ and R⁸ are a halogen atom or a hydrocarbon group, more preferably only one of the radicals R¹, R², R³ and R⁴ and of the radicals R⁵, R⁶, R⁷ and R⁸ in each case being a halogen atom or a hydrocarbon group and in particular all the radicals R¹ to R⁸ being hydrogen atoms.

For the preferred embodiments described in the previous paragraph C₁- to C₆ alkyl groups are preferred as hydrocarbon groups. If the hydrocarbon groups contain a heteroatom, C₁- to C₆ alkoxy groups are the preferred radicals for these versions. The heteroatom is thus then oxygen.

In Formula I the radicals R¹ to R⁸ independently of each other can have the following meanings:

Alkoxy: linear or branched alkyl groups with 1 to 30 carbon atoms (as mentioned above) which are bound via an oxygen atom (—O—) to the skeleton, i.e. the 9,10-dihydro-9-oxa-10-phosphaphenanthrene-10-oxide structure.

Alkylthio: linear or branched alkyl groups with 1 to 30 carbon atoms (as mentioned above) which are bound via a sulphur atom (—S—) to the skeleton.

Optionally substituted alkyl: saturated, linear or branched hydrocarbon radicals, in particular with 1 to 10 carbon atoms, e.g. C₁- to C₆ alkyl such as methyl, ethyl, propyl, 1-methyl ethyl, butyl, 1-methyl propyl, 2-methyl propyl, 1,1-dimethyl ethyl, pentyl, 1-methyl butyl, 2-methyl butyl, 3-methyl butyl, 2,2-dimethyl propyl, 1-ethyl propyl, hexyl, 1,1-dimethyl propyl, 1,2-dimethyl propyl, -1-methyl pentyl, 2-methyl pentyl, 3-methyl pentyl, 4-methyl pentyl, 1,1-dimethyl butyl, 1,2-dimethyl butyl, 1,3-dimethyl butyl, 2,2-dimethyl butyl, 2,3-dimethyl butyl, 3,3-dimethyl butyl, 1-ethyl butyl, 2-ethyl butyl, 1,3-trimethyl propyl, 1,2,2-trimethyl propyl, 1-ethyl-1-methyl propyl and 1-ethyl-2-methyl propyl.

Optionally substituted alkenyl: saturated, linear or branched hydrocarbon radicals, in particular with 2 to 10 hydrocarbon atoms and a double bond in any position, e.g. C₂- to C₆ alkenyl such as ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 1,1,2-trimethyl-2-propenyl, 1-ethyl-1-methyl-2-propenyl, 1-ethyl-2-methyl-2-propenyl and 1-ethyl-2-methyl-2-propenyl.

Optionally substituted alkinyl: linear or branched hydrocarbon groups, in particular with 2 to 20 hydrocarbon atoms and a triple bond in any position, e.g. C₂- to C₆ alkinyl such as ethinyl, 1-propinyl, 2-propinyl, 1-butinyl, 2-butinyl, 3-butinyl, 1-methyl-2-propinyl, 1-pentinyl, 2-pentinyl, 3-pentinyl, 4-pentinyl, 1-methyl-2-butinyl, 1-methyl-3-butinyl, 2-methyl-3-butinyl, 3-methyl-1-butinyl, 1,1-dimethyl-2-propinyl, 1-ethyl-2-propinyl, 1-hexinyl, 2-hexinyl, 3-hexinyl, 4-hexinyl, 5-hexinyl, 1-methyl-2-pentinyl, 1-methyl-3-pentinyl, 1-methyl-4-pentinyl, 2methyl-3-pentinyl, 2-methyl-4-pentinyl, 3-methyl-1-pentinyl, 3-methyl-4-pentinyl, 4-methyl-1-pentinyl, 4-methyl-2-pentinyl, 1,1dimethyl-2-butinyl, 1,1-dimehyl-3-butinyl, 1,2-dimethyl-3-butinyl, 2,2-dimethyl-3-butinyl, 3,3-dimethyl-1-butinyl, 1-ethyl-2-butinyl, 1-ethyl-3-butinyl, 2-ethyl-3-butinyl and 1-ethyl-1-methyl-2-propinyl.

An optionally substituted, saturated or a once- or twice-unsaturated ring which along with carbon atoms can contain one to three of the following heteroatoms as ring members: oxygen, sulphur and nitrogen, for example carbocycles such as cyclopropyl, cyclopentyl, cyclohexyl, cyclopent-2-enyl, cyclohex-2-enyl, 5- to 6-membered, saturated or unsaturated heterocycles, containing one to three nitrogen atoms and/or an oxygen or sulphur atom such as 2-tetrahydrofuranyl, 3-tetrahydrofuranyl, 2-tetrahydrothienyl, 3-tetrahydrothienyl, 2-pyrrolidinyl, 3-pyrrolidinyl, 3-isoxazolidinyl, 4-isoxazolidinyl, 5-isoxazolidinyl, 3-isothiazolidinyl, 4-isothiazolidinyl, 5-isothiazolidinyl, 3-pyrazolidinyl, 4-pyrazolidinyl, 5-pyrazolidinyl, 2-oxazolidinyl, 4-oxazolidinyl, 5-oxazolidinyl, 2-thiazolidinyl, 4-thiazolidinyl, 5-thiazolidinyl, 2-imidazolidinyl, 4-imidazolidinyl, 1,2,4-oxadiazolidin -3-yl, 1,2,4-oxadiazolidin-5-yl, 1,2,4-thiadiazolidin-3-yl, 1,2,4-thiadiazolidin-5-yl, 1,2,4-triazolidin-3-yl, 1,3,4-oxadiazolidin-2-yl, 1,3,4-thiadiazolidin-2-yl, 1,3,4-triazolidin-2-yl, 2,3-dihydrofur-2-yl, 2,3-dihydrofur-3-yl, 2,4-dihydrofur-2-yl, 2,4-dihydrofur-3-yl, 2,3-dihydrothien-2-yl, 2,3-dihydrothien-3-yl, 2,4-dihydrothien-2-yl, 2,4-dihydrothien-3-yl, 2,3-pyrrolin-2-yl, 2,3-pyrrolin-3-yl, 2,4-pyrrolin-2-yl, 2,4-pyrrolin-3-yl, 2,3-isoxazolin-3-yl, 3,4-isoxazolin-3-yl, 4,5-isoxaolin-3-yl, 2,3-isoxazolin-4-yl, 3,4-isoxazolin-4-yl, 4,5-isoxazolin-4-yl, 2,3-isoxazolin-5-yl, 3,4-isoxazolin-5-yl, 4,5-isoxazolin-5-yl, 2,3-isothiazolin-3-yl, 3,4-isothiazolin-3-yl, 4,5-isothiazolin-3-yl, 2,3-isothiazolin-4-yl, 3,4-isothiazolin-4-yl, 4,5-isothiazolin-4-yl, 2,3-isothiazolin-5-yl, 3,4-isothiazolin-5-yl, 4,5-isothiazolin-5-yl, 2,3-dihydropyrazol-1-yl, 2,3-dihydropyrazol-2-yl, 2,3-dihydropyrazol-3-yl, 2,3-dihydropyrazol-4-yl, 2,3-dihydropyrazol-5-yl, 3,4-dihydropyrazol-1-yl, 3,4-dihydropyrazol-3-yl, 3,4-dihydropyrazol-4-yl, 3,4-dihydropyrazol-5-yl, 4,5-dihydropyrazol-1-yl, 4,5-dihydropyrazol-3-yl, 4,5-dihydropyrazol-4-yl, 4,5-dihydropyrazol-5-yl, 2,3-dihydrooxazol-2-yl, 2,3-dihydrooxazol-3-yl, 2,3-dihydrooxazol-4-yl, 2,3-dihydrooxazol-5-yl, 3,4-dihydrooxazol-2-yl, 3,4-dihydrooxazol-3-yl, 3,4-dihydrooxazol-4-yl, 3,4-dihydrooxazol-5-yl, 3,4-dihydrooxazol-2-yl, 3,4-dihydrooxazol-3-yl, 3,4-dihydrooxazol-4-yl, 2-piperidinyl, 3-piperidinyl, 4-piperidinyl, 1,3-dioxan-5-yl, 2-tetrahydropyranyl, 4-tetrahydropyranyl, 2-tetrahydrothienyl, 3-tetrahydropyridazinyl, 4-tetrahydropyridazinyl, 2-tetrahydropyrimidinyl, 4-tetrahydropyrimidinyl, 5-tetrahydropyrimidinyl, 2-tetrahydropyrazinyl, -1,3,5-tetrahydro-triazin-2-yl and 1,2,4-tetrahydrotriazin-3-yl, preferably 2-tetrahydrofuranyl, 2-tetrahydrothienyl, 2-pyrrolidinyl, 3-isoxazolidinyl, 3-isothiazolidinyl, 1,3,4-oxazolidin-2-yl, 2,3-dihydrothien-2-yl, 4,5-isoxazolin-3-yl, 3-piperidinyl, 1,3-dioxan-5-yl, 4-piperidinyl, 2-tetrahydropyranyl, 4-tetrahydropyranyl.

An optionally substituted one- or two-core aromatic ring system which along with carbon atoms can contain one to four nitrogen atoms or one or two nitrogen atoms and one oxygen or sulphur atom or one oxygen or sulphur atom as ring members: i.e. aryl radicals such as phenyl and naphthyl, preferably phenyl or 1-or 2-naphthyl, and hetaryl radicals, for example 5-ring heteroaromatics containing one to three nitrogen atoms and/or one oxygen or sulphur atom such as 2-furyl, 3-furyl, 2-thienyl, 3-thienyl, 1-pyrrolyl, 2-pyrrolyl, 3-pyrrolyl, 3-isoxazolyl, 4-isoxazolyl, 5-isoxazolyl, 3-isothiazolyl, 4-isothiazolyl, 5-isothiazolyl, 1-pyrazolyl, 3-pyrazolyl, 4-pyrazolyl, 5-pyrazolyl, 2-oxazolyl, 4-oxazolyl, 5-oxazolyl, 2-thiazolyl, 4-thiazolyl, 5-thiazolyl, 1-imidazolyl, 2-imidazolyl, 4-imidazolyl, 1,2,4-oxadiazol-3-yl, 1,2,4-oxadiazol-5-yl, 1,2,4-thiadiazol-3-yl, 1,2,4-thiadiazol-5-yl, 1,2,5-triazol-3-yl, 1,2,3-triazol-4-yl, 1,2,3-triazol-5-yl, 5-tetrazolyl, 1,2,3,4-thiatriazole and 1,2,3,4-oxatriazol-5-yl, in particular 3-isoxazolyl, 5-isoxazolyl, 4-oxazolyl, 4-thiazolyl, 1,3,4-oxadiazol-2-yl and 1,3,4-thiadiazol-2-yl.

Six-ring heteroaromatics containing one to four nitrogen atoms as heteroatoms such as 2-pyridinyl, 3-pyridinyl, 4-pyridinyl, 3-pyradazinyl, 4-pyradazinyl, 2-pyrimidinyl, 4-pyrimidinyl, 5-pyrimidinyl, 2-pyrazinyl, 1,3,5-triazin-2-yl, 1,2,4-triazin-3-yl and 1,2,4,5-tetrazin-3-yl, in particular 2-pyridinyl, 3-pyridinyl, 4-pyridinyl, 2-pyrimidinyl, 4-pyrimidinyl, 2-pyrazinyl and 4-pyrazinyl.

The addition “optionally substituted”, in relation to alkyl, alkenyl and alkinyl groups is intended to express that these groups can be partially or completely halogenated (i.e. the hydrogen atoms of these groups can be partially or completely replaced by the same or different halogen atoms as mentioned above (preferably fluorine, chorine and bromine, in particular fluorine and chlorine) and/or can carry one to three, in particular one of the following radicals:

Nitro, cyano, C₁- to C₄ alkoxy, C₁- to C₄ alkoxycarbonyl or an optionally substituted one- or two-core aromatic ring system which along with carbon atoms can contain one to four nitrogen atoms or one or two nitrogen atoms and one oxygen or sulphur atom or one oxygen or sulphur atom as ring members, i.e. aryl radicals such as phenyl and naphthyl, preferably phenyl or 1- or 2-naphthyl, and hetaryl radicals, for example 5-ring heteroaromatics containing one to three nitrogen atoms and/or an oxygen or sulphur atom such as 2-furyl, 3-furyl, 2-thienyl, 3-thienyl, 1-pyrrolyl, 2-pyrrolyl, 3-pyrrolyl, 3-isoxazolyl, 4-isoxazolyl, 5-isoxazolyl, 3-isothiazolyl, 4-isothiazolyl, 5-isothiazolyl, 1-pyrazolyl, 3-pyrazolyl, 4-pyrazolyl, 5-pyrazolyl, 2-oxazolyl, 4-oxazolyl, 5-oxazolyl, 2-thiazolyl, 4-thiazolyl, 5-thiazolyl, 1-imidazolyl, 2-imidazolyl, 4-imidiazolyl, 1,2,4-oxadiazolyl-3-yl, 1,2,4-oxadiazol-5-yl, 1,2,4-thiadiazol-3-yl, 1,2,4-thiadiazol-5-yl, 1,2,5-triazol-3-yl, 1,2,3-triazol-4-yl, 1,2,3-triazol-5-yl, 5-tetrazolyl, 1,2,3,4-thiatriazole and 1,2,3,4-oxatriazol-5-yl, in particular 3-isoxazolyl, 5-isoxazolyl, 4-oxazolyl, 4-thiazolyl, 1,3,4-oxadiazol-2-yl and 1,3,4-thiadiazol-2-yl.

Furthermore the substituents can be six-ring heteroaromatics containing one to four nitrogen atoms as heteroatoms such as 2-pyridinyl, 3-pyridinyl, 4-pyridinyl, 3-pyradazinyl, 4-pyradazinyl, 2-pyrimidinyl, 4-pyrimidinyl, 5-pyrimidinyl, 2-pyrazinyl, 1,3,5-triazin-2-yl, 1,2,4-triazin-3-yl and 1,2,4,5-tetrazin-3-yl, in particular 2-pyridinyl, 3-pyridinyl, 4-pyridinyl, 2-pyrimidinyl, 4-pyrimidinyl, 2-pyrazinyl and 4-pyrazinyl.

The addition “optionally substituted” in relation to the cyclic (saturated, unsaturated or aromatic) groups is intended to express that these groups can be partially or completely halogenated (i.e. the hydrogen atoms of these groups can be partially or completely replaced by the same or different halogen atoms as named above (preferably fluorine, chlorine and bromine, in particular fluorine and chlorine) and/or can carry one to three, preferably one of the following radicals: nitro, cyano, C₁- to C₄ alkyl, C₁- to C₄ alkoxy and C₁- to C₄ alkoxycarbonyl.

The one- or two-core aromatic or heteroaromatic systems mentioned in the case of the radicals can for their part be partially or completely halogenated, i.e. the hydrogen atoms of these groups can be partially or completely replaced by halogen atoms such as fluorine, chlorine, bromine and iodine, preferably fluorine and chlorine.

These one- or two-core aromatic or heteroaromatic systems can, along with the mentioned halogen atoms, carry in addition one to three of the following substituents:
Nitro, cyano, thiocyanato;
Alkyl, in particular C₁- to C₆ alkyl as mentioned above,
C₁- to C₃₀ alkoxy,
C₁- to C₃₀ alkylthio,
C₁- to C₄ alkylamino,
C₁- to C₆ alkylcarbonyl,
C₁- to C₆ alkoxycarbonyl,
C₁- to C₆ alkylaminocarbonyl,
C₁- to C₆ alkylcarboxyl,
C₁- to C₆ alkyldarbonylamino,
C₃- to C₇ cycloalkyl such as cyclopropyl, cyclobutyl, cyclopentyl, cyclohexyl and cycloheptyl, preferably cyclopropyl, cyclopentyl and cyclohexyl, in particular cyclopropyl;
C₃- to C₇ cycloalkoxy such as cyclopropyloxy, cyclobutyloxy, cyclopentyloxy, cyclohexyloxy and cycloheptyloxy, preferably cyclopentyloxy and cyclohexyloxy, in particular cyclohexyloxy;
C₃- to C₇ cycloalkylthio such as cyclopropylthio, cyclobutylthio, cyclopentylthio, cyclohexylthio and cycloheptylthio, preferably cyclohexylthio;
C₃- to C₇ cycloalkylamino such as cyclopropylamino, cyclobutylamino, cyclopentylamino, cyclohexylamino and cycloheptylamino, preferably cyclopropylamino and cyclohexylamino, in particular cyclopropylamino;
further radicals for optionally substituted one- or two-core aromatic or heteroaromatic radicals:
Alkenyl, alkinyl, haloalkenyl, haloalkinyl, alkenyloxy, alkinyloxy, haloalkenyloxy, haloalkinyloxy, alkenylthio, alkinylthio, alkylsulphoxy, alkylsulphonyl, alkenylsulphoxy, alkinylsulphoxy, alkinylsulphonyl.

Although the radicals R¹ to R⁸ can be halogens, such as fluorine, chlorine, bromine or iodine, preferably chlorine or bromine, derivatives are preferred in which none of the radicals R¹ to R⁸ is a halogen atom. Accordingly, derivatives are preferred in which none of the radicals R¹ to R¹¹ contains halogen atoms. Halogen-free derivatives are therefore preferred according to the invention.

In a preferred version R⁹ is a hydrogen atom, an alkyl or an aryl group, the definitions of terms relating to the radicals R¹ to R⁸ applying accordingly and a hydrogen atom or a methyl group are particularly preferred.

Preferred radicals R¹⁰ and R¹¹ independently of each other are selected from alkyl, alkenyl, alkinyl, aryl and glycidyl groups, the definitions of terms relating to the radicals R¹ to R⁸ applying accordingly, and methyl, ethyl and allyl are particularly preferred. In a further preferred embodiment the radicals R¹⁰ and R¹¹ are the same. Further examples of the radicals R¹⁰ and R¹¹ are the optionally substituted alkyl, alkenyl and alkinyl radicals listed above in relation to the definitions of R¹ to R⁸ as well as the above-mentioned, optionally substituted, saturated or once- or twice-unsaturated rings.

The details of preferred versions for the radicals R¹ to R¹¹ for the derivative according to the invention also apply accordingly to the process according to the invention for the preparation of the derivatives, the use of the derivatives for flame protection of natural products and plastics, the process for flameproof finishing of natural products and plastics and the flameproof-finished natural products and plastics.

Moreover the invention relates to a process for the preparation of the derivatives of 9,10-dihydro-9-oxa-10-phosphaphenanthrene-10-oxide according to the Formula I above by reaction of 9,10-dihydro-9-oxa-10-phosphaphenanthrene-10-oxide (DOP) or of its derivatives according to the Formulae IIa or IIb 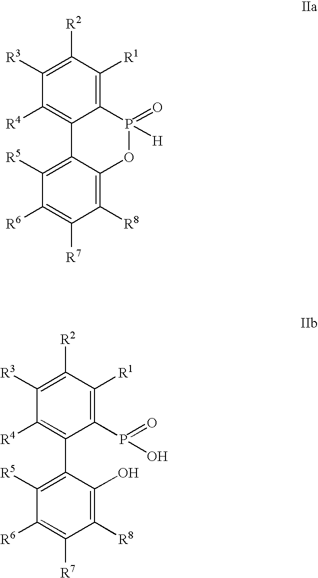
with one or more ortho acid derivatives of the Formula R⁹CX₃ and production of the derivative,
R¹ to R⁸ independently of each other being a hydrogen atom, halogen atom or a hydrocarbon group,
R⁹ being a hydrogen atom or a hydrocarbon group and
the radicals X being the same or different and meaning OR¹⁰ or NR¹⁰R¹¹ and R¹⁰ and R¹¹ being the same or different hydrocarbon groups, R¹¹ also being able to be hydrogen,
   the radicals R¹ to R¹¹ independently of each other optionally containing one or more heteroatoms selected from oxygen, nitrogen, sulphur, phosphorus, silicon and halogen,
   two or more of the radicals R¹⁰ to R¹¹ optionally being linked to form one or more cycles and
   the radicals R¹⁰ to R¹¹ optionally being linked to form a cycle.

The radicals X are preferably the same.

When the term DOP is used in the description of the present invention, this relates to the case where all the radicals R¹ to R⁸ in the educt of the Formula IIa are hydrogen atoms.

The process according to the invention is preferably carried out in the presence of acid catalyst, the catalyst preferably being a protonic acid or a Lewis acid, preferably acid resin, sulphonic acid, mineral acid, trifluoroacetic acid, BF₃, FeCl₃ or SnCl₄, in particular hydrogen chloride or concentrated aqueous hydrochloric acid.

When carrying out the process according to the invention it is possible for example to introduce the educt of the Formulae IIa/IIb, and ortho acid derivative (optionally in aprotic solvent) and then to carry out the reaction, optionally while adding catalyst. The molar ratio of ortho acid derivative to educt of Formula IIa can for example be in the range of 50:1 to 1.01:1. When using educt according to Formula IIb the molar ratio of ortho acid derivative to educt can for example be in the range of 50:1 to 2.01:1. In this version comparatively more ortho acid derivative is required for the intramolecular esterification of compound according to Formula IIb (a hydroxybiphenyl phosphinic acid).

The reaction temperature can be from −20° C. to boiling point of the solvents mentioned below. Preferably reaction takes place at ambient temperature. The pressure is normally normal pressure.

According to one embodiment of the process according to the invention the reaction is carried out without solvent. Then only the educt of Formulae IIa/b and the ortho ester R⁹CX₃ (X=OR¹⁰) and/or the ortho amide R⁹CX₃ (X₃=NR¹⁰R¹¹) and optionally the acid catalyst are reacted with each other. In such an embodiment ortho ester and/or ortho amide is/are used in molar excess, relative to the educt of Formulae IIa/b. In the solvent free variant of the process according to the invention the molar excess of ortho acid derivative to educt of Formula II is usually greater, for example in the range of 40:1 to 5:1, preferably 30:1 to 7:1, in particular 25:1 to 10:1, such as 20:1 to 15:1.

Alternatively it is possible to carry out the reaction in the presence of aprotic solvent, e.g. in aromatics such as benzene, toluene, xylene, chlorinated hydrocarbons such as chlorobenzene, chloralkane, ethers such as dioxan, methyl-tert.butyl ether, tetrahydrofuran, preferably in toluene. In the variant of the process according to the invention in which the reaction is carried out in the presence of aprotic solvent, the molar excess of ortho acid derivative to educt of Formula II is comparatively less, for example in the range of 5:1 to 1.1:1, more preferably 4:1 to 1.5:1, in particular 3.5:1 to 2.5:1, such as about 3:1.

In a preferred embodiment the reaction takes place without the use, and preferably in the absence, of protic solvent, in particular without the use or in the absence of alcohol, amine and/or water. In the description of the present invention protic substances possibly present during the reaction, used as catalyst, and alcohol R¹⁰OH forming or amine R¹⁰R¹¹NH forming during the reaction in molar quantity, relative to the educt of Formulae IIa/b, are not seen as protic solvent. If necessary, such substances and water can be caught by addition of a stoichiometric excess of ortho ester.

In the process for the preparation of the derivatives according to the invention R¹⁰ and R¹¹ are preferably selected independently of each other from alkyl, alkenyl, alkinyl, aryl and glycidyl groups, more preferably methyl, ethyl and allyl. Preferred as ortho acid derivatives are R⁹C(OR¹⁰)₃ ortho esters, more preferably orthoformic acid ester, in particular trimethyl orthoformate, triethyl orthoformate, or triallyl orthoformate. However ortho esters in which the R¹⁰ radicals are different, can also be used. Particularly preferred is the version of the process in which the compound DOP (with R¹ to R⁸ being hydrogen atoms) is used as educt of Formula IIa.

Moreover the invention relates to the use of the derivatives according to the invention for flame protection of natural products and plastics. The invention also relates to a process for flameproof finishing of natural products and plastics, in which one or more derivatives according to the invention are added to a natural product or plastic. For example one or more derivatives according to the invention are added to an uncured natural product or plastic (synthetic resin) and the mixture of uncured natural product or plastic and the derivative according to the invention is then cured to give a cured natural product or plastic with a flame-retardant finish. The invention moreover relates to natural products and plastics with a flameproof finish, which contain one or more derivatives according to the invention, the derivatives according to the invention being optionally reactively (chemically) bound. Examples of natural products are cotton, wool, linen and hemp.

In a preferred embodiment the invention relates to the flameproof finishing of epoxide resins. Such a flameproof epoxide resin according to the invention preferably contains 2 to 7 wt.-% phosphorus in the resin composition. By “resin composition” is meant only the total weight of epoxide resin used and derivative of Formula I according to the invention. Other optionally used components such as curing agent, filler or glass-fibre mat are not considered in this definition of the phosphorus content. An advantage of the flameproof-finished epoxide resin according to the invention is that it can be prepared using a reactive derivative (e.g. R¹⁰ and/or R¹¹ equals allyl or glycidyl). At least a part of the reactive derivative of Formula I then reacts with the epoxide resin and/or the optionally used curer. According to the invention it is preferred that at least 50 wt.-% of the phosphorus content is chemically bound into the epoxide resin.

Preferred embodiments and advantages of the present invention result in particular from the examples.

### EXAMPLES

### Example 1

### 9-hydro-10-dimethoxymethyl-9-oxa-10-phosphaphenanthrene-10-oxide from 9,10-dihydro-9-oxa-10-phosphaphenanthrene-10-oxide (DOP) and trimethyl orthoformate

0.20 mol (43.23 g) 9,10-dihydro-9-oxa-10-phosphaphenanthrene-10-oxide are suspended at room temperature in 200 ml toluene. 0.55 mol (58.37 g) trimethyl orthoformate are poured in one go into this colourless suspension accompanied by stirring. After 5 mins stirring 3.6 ml concentrated HCl is added dropwise within 10 mins. After the catalyst addition is complete there is a clear, colourless solution. The reaction mixture is stirred at room temperature for a further 30 mins and then all the volatile components are removed under fine vacuum (0.01 mbar). The product is a colourless solid. Yield: 56.88 g, 98% of theory.

### Example 2

### 9-hydro-10-diethoxymethyl-9-oxa-10-phophaphenanthrene-10-oxide from 9,10-dihydro-9-oxa-10-phosphaphenanthrene-10-oxide and triethyl orthoformate

0.45 mol (97.27 g) 9,10-dihydro-9-oxa-10-phosphaphenanthrene-10-oxide are suspended at room temperature in 400 ml toluene. 1.35 mol (200.37 g) triethyl orthoformate are poured in one go into this colourless suspension accompanied by stirring; After 5 mins stirring 1.5 ml concentrated HCl is added dropwise within 5 mins. After the catalyst addition is complete there is a clear, colourless solution. The reaction mixture is stirred at room temperature for a further 30 mins and then all the volatile components are removed under fine vacuum (0.01 mbar). The product is a colourless solid. Yield: 136.07 g, 95% of theory.

### Example 3

### 9-hydro-10-diethoxymethyl-9-oxa-10-phosphaphenanthrene-10-oxide from 9,10-dihydro-9-oxa-10-phosphaphenanthrene-10-oxide and triethyl orthoformate (variant without catalyst)

0.10 mol (21.62 g) 9,10-dihydro-9-oxa-10-phosphaphenanthrene-10-oxide are suspended at room temperature in 1.80 mol (267.66 g) triethyl orthoformate. The reaction mixture is heated to reflux, a clear, colourless solution forming. After boiling for seven days at reflux this is cooled to room temperature and all the volatile components are removed under fine vacuum (0.01 mbar). The product is a colourless solid. Yield: 29.60 g, 93% of theory.

### Example 4

### 9-hydro-10-diallyloxymethyl-9-oxa-10-phosphaphenanthrene-10-oxide from 9,10-dihydro-9-oxa-10-phosphaphenanthrene-10-oxide and triallyl orthoformate

0.10 mol (21.62 g) 9,10-dihydro-9-oxa-10-phoshaphenanthrene-10-oxide are suspended at room temperature in 100 ml toluene. 0.40 mol (73.69 g) triallyl orthoformate is poured at one go into this colourless suspension accompanied by stirring. After 5 min stirring dry hydrogen chloride gas is introduced into the suspension, approx. 2 bubbles per second. After 5 mins the flow of gas is stopped; there is a clear, colourless solution. The reaction mixture is stirred at room temperature for a further 3 hours and then all the volatile components are removed under fine vacuum (0.01 mbar), initially at room temperature, then at 100° C. The product is a colourless, highly viscous liquid. Yied: 32.86 g, 96% of theory.

1. Derivatives of 9,10-dihydro-9-oxa-10-phosphaphenanthrene-10-oxide with Formula I 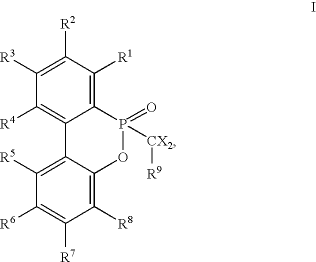
in which
R¹ to R⁸ independently of each other are a hydrogen atom, halogen atom or a hydrocarbon group,
R⁹ is a hydrogen atom or a hydrocarbon group and
the radicals X are the same or different and mean OR¹⁰ or NR¹⁰R¹¹, and R¹⁰ and R¹¹ are the same or different hydrocarbon groups, R¹¹ also being able to be hydrogen,
the radicals R¹ to R¹¹ independently of each other optionally containing one or more heteroatoms selected from oxygen, nitrogen, sulphur, phosphorus, silicon and halogen,
two or more of the radicals R¹ to R⁸ optionally being linked to form one or more cycles and
the radicals R¹⁰ and R¹¹ optionally being linked to form a cycle.

2. Derivative according to claim 1, wherein the two of the radicals X are the same.

3. Derivative according to claim 1, wherein R⁹ is a hydrogen atom, an alkyl or an aryl group, preferably a hydrogen atom or a methyl group.

4. Derivative according to claim 1, wherein R¹⁰ and R¹¹ independently of each other are selected from alkyl, alkenyl, alkinyl, aryl and glycidyl groups, preferably methyl, ethyl and allyl.

5. Derivative according to claim 1, wherein R¹⁰ and R¹¹ are the same.

6. Derivative according to claim 1, wherein of the radicals R¹, R², R³ and R⁴, at least two, preferably at least three are hydrogen atoms, where in particular R¹, R², R³ and R⁴ are all hydrogen atoms.

7. Derivative according to claim 1, wherein of the radicals R⁵, R⁶, R⁷ and R⁸, at least two, preferably at least three are hydrogen atoms, where in particular R⁵, R⁶, R⁷and R⁸ are all hydrogen atoms.

8. Process for the preparation of derivatives of 9,10-dihydro-9-oxa-10-phosphaphenanthrene-10-oxide by reaction of 9,10-dihydro-9-oxa-10-phosphaphenanthrene-10-oxide or its derivatives according to Formulae IIa or IIb 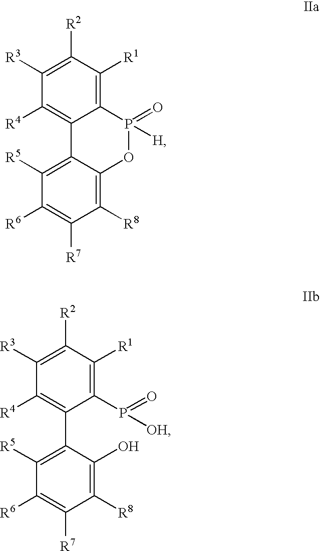
with one or more ortho acid derivatives of Formula R⁹CX₃ and production of the derivative,
R¹ to R⁸ independently of each other being a hydrogen atom, halogen atom or a hydrocarbon group,
R⁹ being a hydrogen atom or a hydrocarbon group and the radicais X being ihe same or different and meaning OR¹⁰ or NR¹⁰R¹¹, and R¹⁰ and R¹¹ being the same or different hydrocarbon groups, R¹¹ also being able to be hydrogen,
the radicals R¹ to R¹¹ independently of each other optionally containing one or more heteroatoms selected from oxygen, nitrogen, sulphur, phosphorus, silicon and halogen,
two or more of the radicals R¹ to R⁸ optionally being linked to form one or more cycles and
the radicals R¹⁰ and R¹¹ optionally being linked to form a cycle.

9. Process according to claim 8, wherein the reaction is carried out in the presence of acid catalyst, the catalyst preferably being a protonic acid or a Lewis acid, preferably acid resin, sulphonic acid, mineral acid, trifluoroacetic acid, BF₃, FeCl₃, SnCl₄, in particular hydrogen chloride or concentrated hydrochloric acid.

10. Process according to claim 8, wherein the reaction is carried out in the presence of aprotic solvent, preferably toluene.

11. Process according to claim 9, wherein the reaction is carried out without the use of protic solvent.

12. Process according to claim 8, wherein R⁹ is a hydrogen atom, an alkyl or aryl group, preferably a hydrogen atom or a methyl group.

13. Process according to claim 8, wherein the two radicals X are the same.

14. Process according to claim 8, wherein R¹⁰ and R¹¹ independently of each other are selected from alkyl, alkenyl, alkinyl, aryl and glycidyl groups, preferably methyl, ethyl and allyl.

15. Process according to claim 14, wherein the ortho acid derivative is an ortho ester R⁹C(OR¹⁰)₃, preferably an orthoformic acid ester, preferably trimethyl orthoformate, triethyl orthoformate or triallyl orthoformate.

16. Process according to claim 8, wherein R¹⁰ and R¹¹ are the same.

17. Use of the derivatives according to claim 1 for flame protection of natural products and plastics.

18. Process for flameproof finishing of natural products and plastics, in which one or more derivatives according to claim 1 are added to a natural product or plastic.

19. Flameproof-finished natural product or plastic which contains one or more derivatives according to claim 1, the derivative optionally being chemically bound.
